(19) United States
(12) Patent Application Publication
(10) Pub. No.: US 2012/0032574 A1
(43) Pub. Date: Feb. 9, 2012

(54) STRUCTURE OF LED (LIGHT-EMITTING DIODE) LIGHTING BULB

(75) Inventors: Ching Feng LIN, Taipei County (TW); Yung Han, Taipei County (TW)

(73) Assignee: JADE YANG CO., LTD., Taipei County (TW)

(21) Appl. No.: 12/967,244

(22) Filed: Dec. 14, 2010

(30) Foreign Application Priority Data
Aug. 5, 2010 (TW) 099215019

(51) Int. Cl. H01J 61/52

(52) U.S. Cl. 313/46

(57) ABSTRACT

A structure of LED (Light-Emitting Diode) lighting bulb has a fin base, a pillar, a circuit board, an electrical connector, and a cover. The fin base forms a bore extending through a central portion and the bore has an inner circumferential surface forming an internal thread. The pillar has an outer circumferential surface forming an external thread, and the pillar is received and retained in the bore through threading engagement. The circuit board is mounted to an end of the pillar, and the circuit board carries an LED and conductor wires. The electrical connector is recessed to form a hollow configuration having an inside surface forming threading, and is coupled to the pillar through threading engagement while electrically connected to the conductor wires. The cover is mounted to the fin base. The mounting arrangement of the pillar and circuit board facilitates replacement of the circuit board and maintenance.

### BACKGROUND OF THE INVENTION

1. Field of the Invention

The present invention relates to a structure of LED (Light-Emitting Diode) lighting bulb, and more particular to a structure of LED lighting bulb composed of a fin base, a pillar, a circuit board, an electrical connector, and a cover, wherein the pillar and the circuit board are arranged to be releasably mounted so that when the circuit board is broken or fails to properly function, the circuit board can be easily replaced to ensure ready maintenance, and the structure is applicable to a regular light bulb, a power-saving light bulb, or the similar lighting bulbs.

2. Description of Related Art

A traditional light bulb comprises tungsten filaments for giving off light. A spherical cover of the traditional light bulb is usually made of glass and contains therein a toxicant substance. When a light bulb not longer works for giving off light, it is common to remove and discard the bulb and a new bulb is instead mounted. This often leads to pollution or contamination to the environment.

The development of science and technology nowadays make it possible to manufacture lighting bulb with LEDs for substitute of the traditional light bulbs that consume a large amount of electrical energy and are not environmentally friendly. The LEDs in the applications as a light bulb must be mounted on a circuit board and electrical connection is made so as to properly energize the LEDs for giving off light. Most of the cases where an LED based lighting bulb does not work properly for giving off light are due to malfunctioning of the circuit board. Thus, when an LED based lighting bulb no longer works, although the cause for malfunctioning can be the circuit board or the LEDs themselves, yet it is not possible for the conventional design to individually replace the circuit board or the LEDs. And, it also requires replacing the whole LED based lighting bulb with a new one. This makes it difficult to lower the cost and also makes it hard for recycling, leading to secondary environmental contamination.

In view of these drawbacks of the conventional lighting, the present invention aims to provide a structure of LED lighting bulb that allows for easy replacement of circuit structure and convenience of maintenance, so that a user may easily conduct a process of replacement and easy use to thereby ensure convenience of use for the general users.

### SUMMARY OF THE INVENTION

Accordingly, the primary objective of the present invention is to provide a structure of LED (Light-Emitting Diode) lighting bulb, which is composed of a fin base, a pillar, a circuit board, an electrical connector, and a cover, wherein the fin base forms a bore extending through a central portion thereof and the pillar is received and retained in the bore of the fin base through threading engagement, whereby with the mounting arrangement of the circuit board and the pillar, easy replacement of the circuit board and ready maintenance can be realized to thereby enhance the overall practicability.

Another objective of the present invention is to provide a structure of LED lighting bulb, which is composed of a cover, a fin base, a pillar, and a circuit board, which are mounted in a releasable manner so as to allow for individual replacement of a single component and thus a reduction of maintenance cost to thereby improve overall convenience.

A further objective of the present invention is to provide a structure of LED lighting bulb, which comprises a fin base that is extended to form a shaped hood, whereby through the shaped hood, heat dissipation is improved and diverse variation of configuration is realized to thereby improve overall practicability.

In order to achieve the above objectives, according to the present invention, a structure of LED lighting bulb comprises a fin base, a pillar, a circuit board, an electrical connector, and a cover. The fin base forms a bore extending through a central portion thereof and the bore has an inner circumferential surface forming an internal thread. The pillar has an outer circumferential surface forming an external thread, and the pillar is received and retained in the bore of the fin base through threading engagement. The circuit board is mounted to an end of the pillar, and the circuit board carries an LED and conductor wires thereon. The electrical connector is recessed to form a hollow configuration having an inside surface forming threading, and the electrical connector is coupled to the pillar through threading engagement and is electrically connected to the conductor wires of the circuit board. The cover is mounted to the fin base. As such, through the mounting arrangement of the pillar and the circuit board, easy replacement of the circuit board and ready maintenance can be realized.

### BRIEF DESCRIPTION OF THE DRAWINGS

The present invention can be fully understood from the following detailed description and preferred embodiments with reference to the accompanying drawings, in which:

FIG. 1 is a perspective view showing an LED (Light-Emitting Diode) lighting bulb according to an embodiment of the present invention;

FIG. 2 is an exploded view of the LED lighting bulb according to the embodiment of present invention;

FIG. 3 is a cross-sectional view showing the LED lighting bulb according to the embodiment of the present invention;

FIG. 4 is a cross-sectional view showing an LED lighting bulb according to another embodiment of the present invention; and

FIG. 5 is a cross-sectional view showing an LED lighting bulb according to a further embodiment of the present invention.

### DETAILED DESCRIPTION OF THE PREFERRED EMBODIMENTS

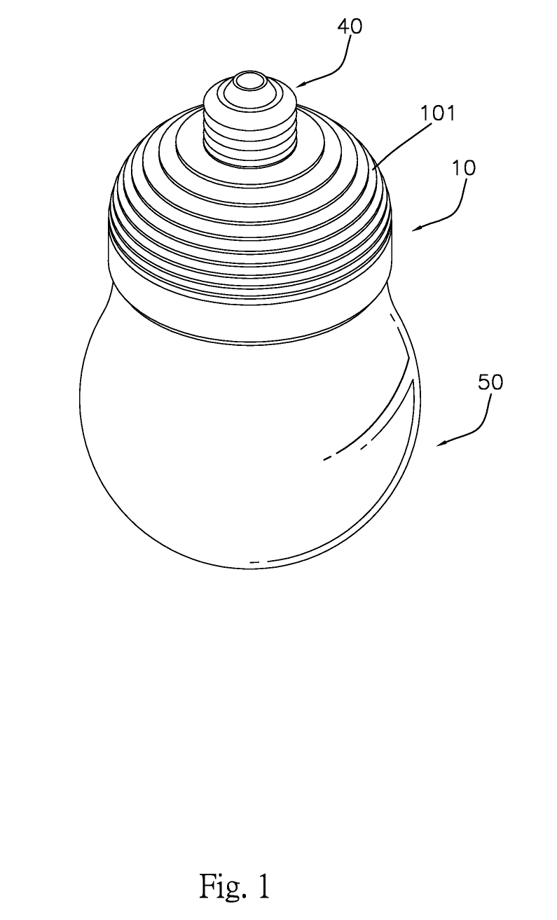

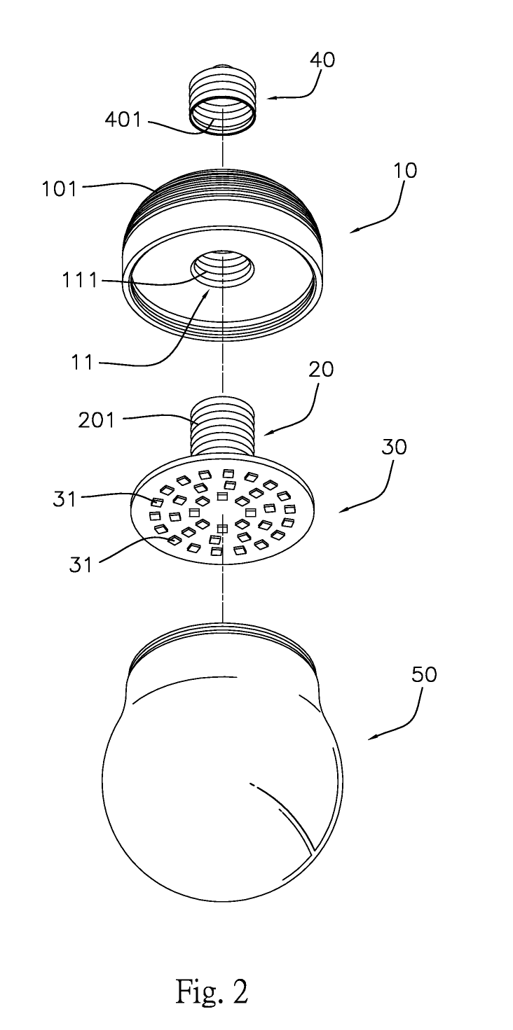

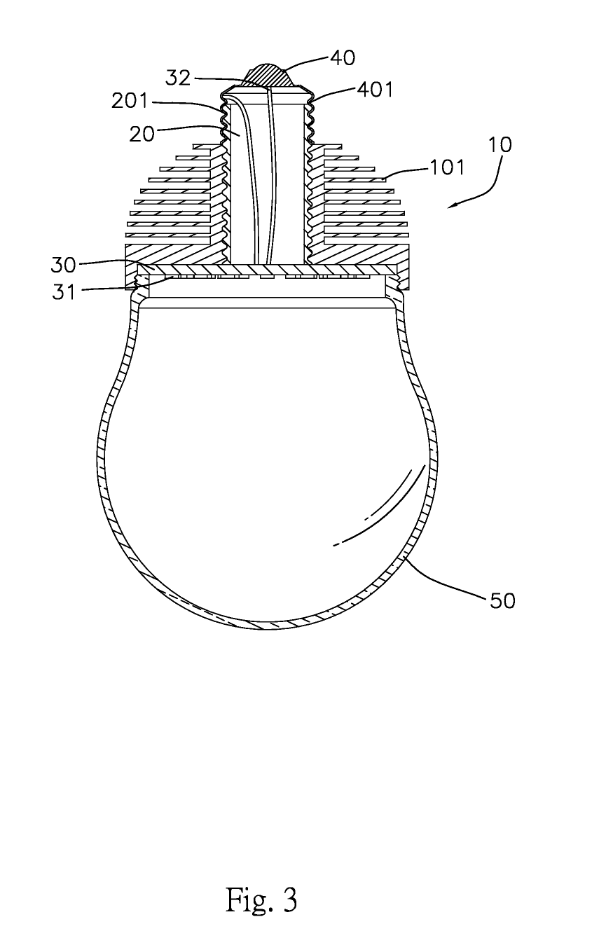

Referring to FIGS. 1-5, embodiments of the present invention are schematically illustrated. The present invention provides a structure of LED (Light-Emitting Diode) lighting bulb, which comprises a fin base 10, a pillar 20, a circuit board 30, an electrical connector 40, and a cover 50. The fin base 10 forms a bore 11 extending through a central portion thereof and the bore 11 has an inner circumferential surface forming an internal thread 111. The pillar 20 has an outer circumferential surface forming an external thread 201. The pillar 20 is received and retained inside the bore 11 of the fin base 10 through threading engagement. The circuit board 30 is mounted to the pillar 20. The circuit board 30 carries thereon LEDs 31 and conductor wires 32. The electrical connector 40 is recessed to form a hollow configuration having an inside surface forming threading 401. The electrical connector 40 is coupled to the pillar 20 through threading engagement and is electrically connected to the conductor wires 32 of the circuit board 30. The cover 50 is coupled to the fin base 10. As such, through the mounting arrangement of the pillar 20 and the circuit board 3, easy replacement of the circuit board 30 and thus ready maintenance can be realized.

The cover 50 and the fin base 10 are made by molding moldable materials, which are preferably colored for identification and showing. The circuit board 30, which is of a circular configuration in the instant embodiment, has an outside diameter smaller than an inside diameter of the pillar 20 to allow the circuit board 30 to be fit inside the pillar 20; or alternatively, the outside diameter of the circuit board 30 is greater than the inside diameter of the pillar 20 to allow the circuit board 30 to be positioned on the fin base 10. The cover 50 and the fin base 10 can be coupled to each other through fitting or threading engagement. The pillar 20 has a length greater than a length of the bore of the fin base 10. Further, the fin base 10 may be alternatively extended, in an outward diverging fashion, to form a shaped hood 12, which helps improving heat dissipation performance.

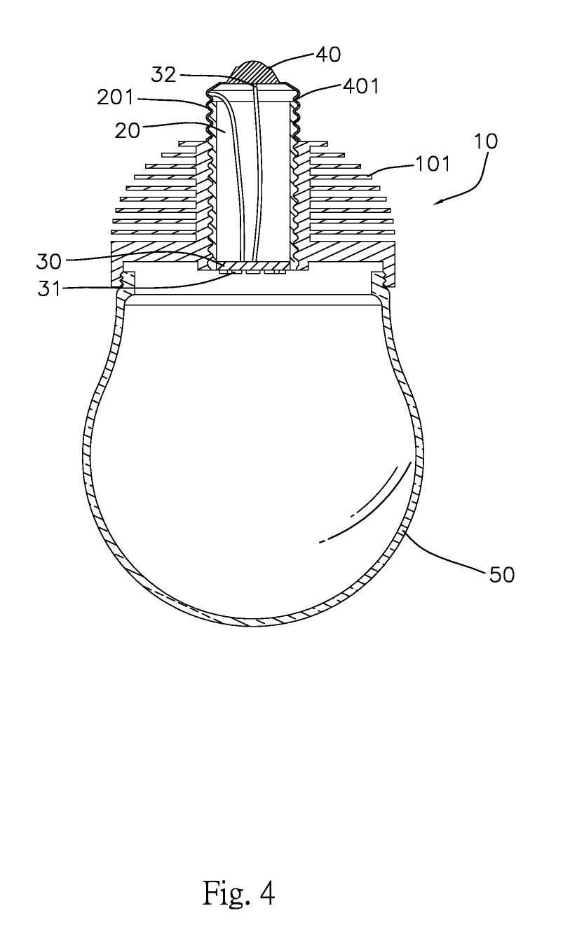

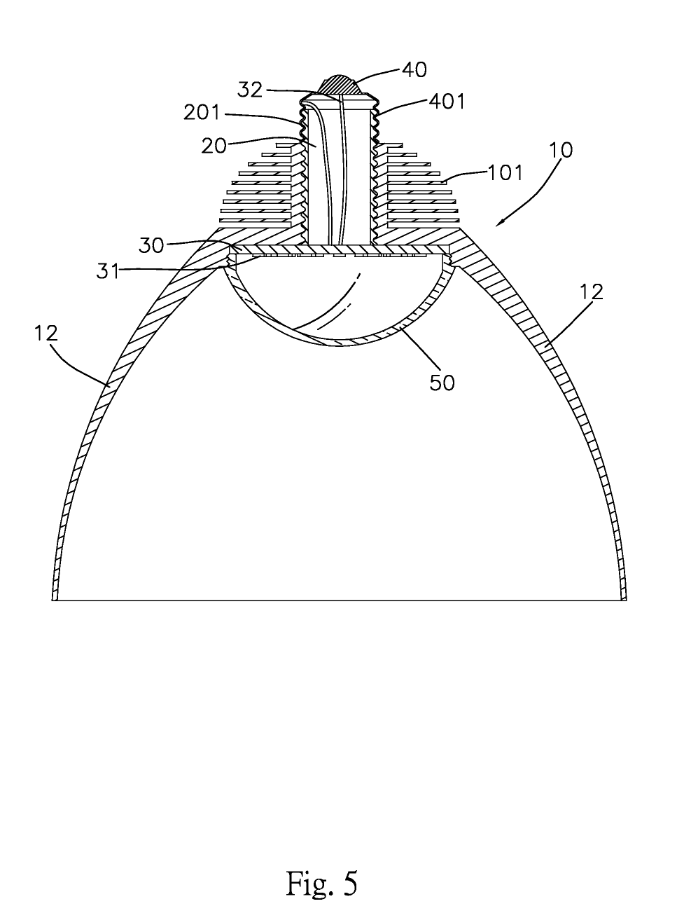

Referring to FIGS. 1-5, which show schematically embodiments according to the present invention, the LED lighting bulb according to the present invention is preferably embodied in the form comprising a fin base 10, a pillar 20, a circuit board 30, an electrical connector 40, and a cover 50. The fin base 10 forms a bore 11 extending through a central portion thereof and the bore 11 has an inner circumferential surface forming an internal thread 111, and the fin base 10 comprises heat dissipation fins 101 mounted thereto for heat dissipation. The fins 101 are each arranged in the form of circumferentially extending ring, or can also be arranged in the form of vertically extending member or of other configuration, and are preferably formed in an integrated fashion as a unitary structure. The fin base 10 is made by molding a moldable material or is made by shaping aluminum materials or other similar materials. The moldable material, when subjected to injection molding, can be added with a desired color to provide vivid color variation on the fin base 10. Further, the pillar 20 has an outer circumferential surface forming an external thread 201, and the pillar 20 is received and retained inside the bore 11 of the fin base 10 through threading engagement, whereby the pillar 20 can be screwed into and out of the fin base 10. The pillar 20 has a length greater than a length of the bore of the fin base 10, so that the electrical connector 40 may be coupled to the pillar 20 through threading engagement, wherein the electrical connector 40 is recessed to form a hollow configuration having an inside surface forming threading 401 for engaging the pillar 20. Further, the pillar 20 has an end to which the circuit board 30 is mounted. The circuit board 30 has an outside diameter greater than an inside diameter of the pillar 20 to allow the circuit board 30 to be positioned on the end of the pillar 20. The circuit board 30 and the pillar 20 are separable from each other. The circuit board 30 is secured to the fin base 10 so that the circuit board 30 is kept fixed and hard to move. The circuit board 30 carries thereon LEDs 31 and conductor wires 32, as well as other electronic components, including a ballast (not shown). The number of the LEDs 31 can be plural to meet the needs of desired lighting performance. The LEDs 31 can be mounted with SMD technology or other techniques of mounting to serve as a light source. Further, the conductor wires 32 extends through hollow interior of the pillar 20 to electrically connect to the electrical connector 40 for connection with a power source for supplying of electrical power. In an alternative form of the present invention (as shown in FIG. 4), the circuit board 30 has an outside diameter that is smaller than an inside diameter of the pillar 20 so that the circuit board 30 can be fit inside the pillar 20 and the circuit board 30 can be held through the pillar 20. Similarly, the circuit board 30 carries thereon LEDs 31 and conductor wires 32, as well as other electronic components, including a ballast (not shown), and the number of the LEDs 31 can be plural to meet the needs of desired lighting performance, and the LEDs 31 can be mounted with SMD technology or other techniques of mounting to serve as a light source. Further, the cover 50 is coupled to the fin base 10 and the coupling between the cover 50 and the fin base 10 is realized through fitting or threading engagement so as to securely fix the cover 50 and the fin base 10 together. The cover 50 can be molded with a moldable material or made of glass. The moldable material is preferably plastic materials or the likes. The cover 50 can be shaped as a sphere so that the cover 50 may provide a large illumination area and form an improved expansion angle of lighting. In another alternative form of the present invention, the fin base 10 is extended to form, in an integral form, a shaped hood 12 (see FIG. 5), and the hood 12 is integrally formed with the fin base 10. The hood 12 can be formed as an extension of heat dissipation fin 101 or assumes any other configuration, so as to provide diverse variation of configuration of the hood 12. Further, through the extension of the hood 12, heat dissipation is improved. Thus, multiple functions are provided.

In summary, the present invention offers the following advantages:

(1) With the structure of the LED lighting bulb provided herein, advantages of easy disassembling, easy maintenance, and reduction of cost can be achieved and environmental conservation can be realized to thereby enhance practicability thereof.

(2) With the shaped hood extending from the fin base, variation of the configuration can be easily made and heat dissipation improved, thereby enhancing the convenience thereof.

What is claimed is:

1. An LED (Light-Emitting Diode) lighting bulb, comprises:
a fin base, which forms a bore extending through a central portion thereof, the bore having an inner circumferential surface forming an internal thread;
a pillar, which has an outer circumferential surface forming an external thread to allow the pillar to be received and retained in the bore of the fin base through threading engagement;
a circuit board, which is mounted to an end of the pillar and carrying thereon an LED and conductor wires;
an electrical connector, which is recessed to form a hollow configuration having an inside surface forming threading, the electrical connector being coupled to the pillar through threading engagement and being electrically connected to the conductor wires of the conductor wires; and
a cover, which is mounted to the fin base,
whereby through the mounting between the pillar and the circuit board, easy replacement and maintenance of the circuit board are realized.

2. The LED lighting bulb according to claim 1, wherein the cover and the fin base are molded with moldable materials.

3. The LED lighting bulb according to claim 2, wherein the moldable materials are colored for identification.

4. The LED lighting bulb according to claim 1, wherein the circuit board has an outside diameter smaller than an inside diameter of the pillar to allow the circuit board to be fit inside the pillar.

5. The LED lighting bulb according to claim 1, wherein the circuit board has an outside diameter greater than an inside diameter of the pillar to allow the circuit board to be mounted to the fin base.

6. The LED lighting bulb according to claim 1, wherein the cover and the fin base are coupled to each other through fitting or threading engagement.

7. The LED lighting bulb according to claim 1, wherein the pillar has a length greater than length of the bore of the fin base.

8. The LED lighting bulb according to claim 1, wherein the fin base is extended to form a hood for improving heat dissipation.
